(19) United States
(12) Patent Application Publication
(10) Pub. No.: US 2025/0240061 A1
(43) Pub. Date: Jul. 24, 2025

(54) MIMO DETECTION CIRCUIT AND METHOD FOR GENERATING LOG-LIKELIHOOD RATIO

(71) Applicant: Samsung Electronics Co., Ltd., Suwon-si, Gyeonggi-do (KR)

(72) Inventors: Junyeong SEO, Suwon-si (KR); Jooyeol YANG, Suwon-si (KR)

(73) Assignee: Samsung Electronics Co., Ltd., Suwon-si, Gyeonggi-do (KR)

(21) Appl. No.: 18/964,892

(22) Filed: Dec. 2, 2024

(30) Foreign Application Priority Data
Jan. 18, 2024 (KR) 10-2024-0008294

(51) Int. Cl. H04B 7/0452; H04L 1/00

(52) U.S. Cl. CPC H04B 7/0452; H04L 1/0054

(57) ABSTRACT

Provided are a multiple input multiple output (MIMO) detection circuit and method for generating a log-likelihood ratio (LLR) by converting a symmetric transmission symbol into an asymmetric transmission symbol corresponding to a modulation order. An LLR generation method in a MIMO system includes converting a symmetric transmission symbol into an asymmetric transmission symbol corresponding to a modulation order, the symmetric transmission symbol being included in a reception signal vector, and generating an LLR based on the reception signal vector, a channel matrix, and the asymmetric transmission symbol by using an LLR generation algorithm.

### CROSS-REFERENCE TO RELATED APPLICATION

This application is based on and claims priority under 35 U.S.C. § 119 to Korean Patent Application No. 10-2024-0008294, filed on Jan. 18, 2024, in the Korean Intellectual Property Office, the disclosure of which is incorporated by reference herein in its entirety.

### BACKGROUND

The inventive concepts relate to wireless communication, and more particularly, to a multiple input multiple output (MIMO) detection circuit and method for generating a log-likelihood ratio (LLR) by using an asymmetric transmission symbol.

Recently, as new radio access technology, 5G (or new radio (NR)) communication systems have aimed to provide a higher-speed data service of several Gbps by using an ultra-wideband with a bandwidth of 100 MHz or more compared to the existing LTE and LTE-A systems. To achieve higher data rates, the implementation of 5G communication systems in an ultra-high-frequency or millimeter-wave (mmWave) band (e.g., a 28 GHz band or a 39 GHz band) has been considered. To reduce the path loss of radio waves and increase the transmission distance of radio waves in the ultra-high-frequency band for 5G communication systems, various technologies such as beamforming, massive MIMO, full-dimension MIMO (FD-MIMO), array antennas, analog beamforming, hybrid beamforming, and large-scale antennas have been discussed.

Moreover, as modulation orders and ranks increase, the burden of symbol detection may increase.

### SUMMARY

The inventive concepts provide a multiple input multiple output (MIMO) detection circuit and method for generating a log-likelihood ratio (LLR) by converting a symmetric transmission symbol into an asymmetric transmission symbol and calculating a Euclidean distance based on the asymmetric transmission symbol. According to embodiments, the burden of symbol detection may be reduced.

According to an aspect of the inventive concepts, there is provided a log-likelihood ratio (LLR) generation method in a multiple input multiple output (MIMO) system, the LLR generation method including converting a symmetric transmission symbol into an asymmetric transmission symbol corresponding to a modulation order, the symmetric transmission symbol being included in a reception signal vector, and generating an LLR based on the reception signal vector, a channel matrix, and the asymmetric transmission symbol by using an LLR generation algorithm.

According to an aspect of the inventive concepts, there is provided a log-likelihood ratio (LLR) generation method in a multiple input multiple output (MIMO) system, the LLR generation method including generating a first common variable based on a reception signal vector and a channel matrix, obtaining asymmetric transmission symbols based on the reception signal vector, the asymmetric transmission symbols having asymmetry corresponding to a modulation order, selecting N transmission symbols from among the asymmetric transmission symbols, “N” being a natural number, calculating a Euclidean distance based on the first common variable and the N transmission symbols, and generating an LLR based on the Euclidean distance by using a max-log MAP algorithm.

According to an aspect of the inventive concepts, there is provided a multiple input multiple output (MIMO) detection circuit provided in a receiving device of a MIMO system, the MIMO detection circuit including processing circuitry configured to generate a first common variable based on a reception signal vector and a channel matrix, convert a symmetric transmission symbol into an asymmetric transmission symbol corresponding to a modulation order, the symmetric transmission symbol being included in the reception signal vector, calculate a Euclidean distance based on the first common variable and the asymmetric transmission symbol, and generate a log-likelihood ratio (LLR) based on the Euclidean distance.

### BRIEF DESCRIPTION OF THE DRAWINGS

Embodiments will be more clearly understood from the following detailed description taken in conjunction with the accompanying drawings in which:

FIG. 1 is a block diagram illustrating a wireless communication system according to embodiments;

FIG. 2 is a block diagram illustrating a receiving device according to embodiments;

FIG. 3 is a block diagram illustrating a communication circuit according to embodiments;

FIG. 4 is a block diagram illustrating a multiple input multiple output (MIMO) environment according to embodiments;

FIG. 5 is a block diagram illustrating a MIMO detection circuit according to a comparative example;

FIGS. 6A and 6B are block diagrams illustrating a MIMO detection circuit according to embodiments;

FIG. 7 is a flowchart illustrating a log-likelihood ratio (LLR) generation method in a MIMO system, according to embodiments;

FIG. 8 is a flowchart illustrating an LLR generation method in a MIMO system, according to embodiments;

FIG. 9 is a block diagram illustrating a wireless communication device according to embodiments; and

FIG. 10 is a conceptual diagram illustrating an Internet of Things (IoT) network system according to embodiments.

### DETAILED DESCRIPTION

Hereinafter, embodiments will be described in detail with reference to the accompanying drawings.

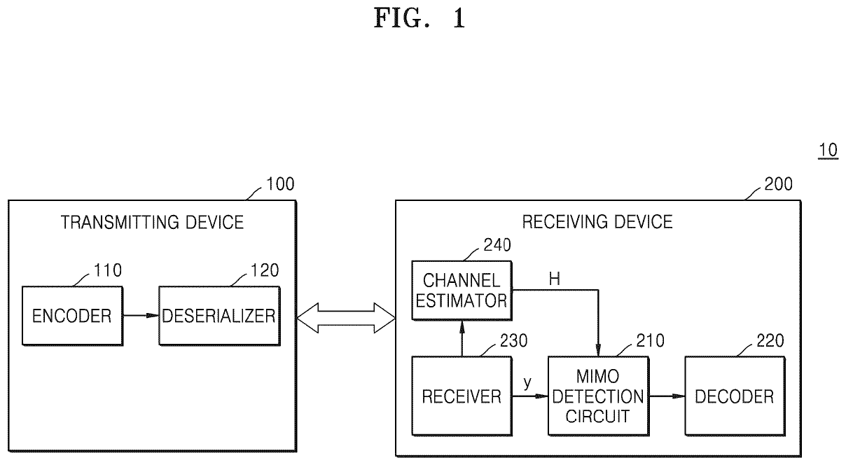

FIG. 1 is a block diagram illustrating a wireless communication system 10 according to embodiments.

Referring to FIG. 1, the wireless communication system 10 may include a transmitting device 100 and a receiving device 200. The transmitting device 100 may refer to a device for encoding data and transmitting a signal through a wireless channel. For example, when the signal is an uplink signal, the transmitting device 100 may correspond to a user equipment and the receiving device 200 may correspond to a base station. As another example, when the signal is a downlink signal, the transmitting device 100 may correspond to a base station and the receiving device 200 may correspond to a user equipment.

The receiving device 200 may access the wireless communication system 10 by exchanging signals with the transmitting device 100. The wireless communication system 10 accessible by the receiving device 200 may be referred to as radio access technology (RAT). Hereinafter, the wireless communication system 10 accessed by the receiving device 200 will be described based on the wireless communication system 10 in the context of a new radio (NR) network, particularly, based on the 3GPP release; however, the inventive concepts are not limited to the NR network and may also be applied to other wireless communication systems with similar technical backgrounds or channel settings (e.g., long term evolution (LTE), LTE-advanced (LTE-A), wireless broadband (WiBro), global system for mobile communication (GSM), cellular communication systems such as next-generation communication (for example, 6G), non-terrestrial network (NTN) communication systems, and/or short-range communication systems such as Bluetooth and near field communication (NFC).

The transmitting device 100 may include an encoder 110 and/or a deserializer 120. The encoder 110 may encode data according to various encoding schemes. In embodiments, the encoder 110 may perform encoding based on at least one of turbo code, convolutional code, and/or polar code.

The deserializer 120 may deserialize a serial bit string. The deserializer 120 may receive a bit string of encoded codewords from the encoder 110 and deserialize the serial bit string by the number of multiple inputs. In embodiments, the deserializer 120 may deserialize the serial bit string and map the results thereof to a plurality of layers respectively. The plurality of layers may correspond to each rank of multiple input multiple output (MIMO). For example, in the case of the wireless communication system 10 of 4×4 MIMO, the serial bit string may be deserialized into four bit strings.

The receiving device 200 may include a MIMO detection circuit 210, a decoder 220, a receiver 230, and/or a channel estimator 240. The receiving device 200 may receive a signal from the transmitting device 100 through the receiver 230. The receiving device 200 may transmit the received signal to the channel estimator 240 and the MIMO detection circuit 210. The received signal may be referred to as a reception signal vector y.

The channel estimator 240 may estimate a channel between the receiving device 200 and the transmitting device 100 based on a pilot symbol of the received signal. The channel estimator 240 may transmit the estimated channel to the MIMO detection circuit 210. The estimated channel may be referred to as a channel matrix H.

The MIMO detection circuit 210 may detect a MIMO signal. The MIMO detection circuit 210 may generate soft decision information in the process of detecting the MIMO signal in order to perform error correction through the decoder 220. For example, the MIMO detection circuit 210 may be based on a linear detection scheme using minimum mean squared error (MMSE), zero-forcing (ZF), and/or matched filter (MF), and/or may be based on a nonlinear detection scheme using maximum likelihood (ML).

In embodiments, the MIMO detection circuit 210 may convert a symmetric transmission symbol (e.g., the pilot symbol of the reception signal vector y) into an asymmetric transmission symbol corresponding to a modulation order (e.g., a modulation order of the received signal containing the symmetric transmission symbol). In the 3GPP release, transmission symbols may be defined according to modulation orders (e.g., corresponding to a number of different transmission symbols transmittable using a given modulation scheme) as the following table.

TABLE 1

| Modulation | |
|---|---|
| order | |
| (MOD) | Transmission symbol (x) |
| QPSK | $x = \frac{1}{\sqrt{2}} \{ ( 1 - 2 {b}_{0} ) + j ( 1 - 2 {b}_{1} ) \} .$ |
| 16QAM | $x = \frac{1}{\sqrt{10}} \{ ( 1 - 2 {b}_{0} ) [ 2 - ( 1 - 2 {b}_{2} ) ] + j ( 1 - 2 {b}_{1} ) [ 2 - ( 1 - 2 {b}_{3} ) ] \}$ |
| 64QAM | $x = \frac{1}{\sqrt{42}} \{ ( 1 - 2 {b}_{0} ) [ 4 - ( 1 - 2 {b}_{2} ) [ 2 - ( 1 - 2 {b}_{4} ) ] ] + j ( 1 - 2 {b}_{1} ) [ 4 - ( 1 - 2 {b}_{3} ) [ 2 - ( 1 - 2 {b}_{5} ) ] ] \}$ |
| 256QAM | $x = \frac{1}{\sqrt{170}} \{ ( 1 - 2 {b}_{0} ) [ 8 - ( 1 - 2 {b}_{2} ) [ 4 - ( 1 - 2 {b}_{4} ) [ 2 - ( 1 - 2 {b}_{6} ) ] ] ] + \\ j ( 1 - 2 {b}_{1} ) [ 8 - ( 1 - 2 {b}_{3} ) [ 4 - ( 1 - 2 {b}_{5} ) [ 2 - ( 1 - 2 {b}_{7} ) ] ] ] \}$ |
| 1024QAM | $x = \frac{1}{\sqrt{682}} \{ ( 1 - 2 {b}_{0} ) [ 16 - ( 1 - 2 {b}_{2} ) [ 8 - ( 1 - 2 {b}_{4} ) [ 4 - ( 1 - 2 {b}_{6} ) [ 2 - ( 1 - 2 {b}_{8} ) ] ] ] ] + \\ j ( 1 - 2 {b}_{1} ) [ 16 - ( 1 - 2 {b}_{3} ) [ 8 - ( 1 - 2 {b}_{5} ) [ 4 - ( 1 - 2 {b}_{7} ) [ 2 - ( 1 - 2 {b}_{9} ) ] ] ] ] \}$ |

In Table 1, bₙ may denote an n-th bit value corresponding to a transmission symbol x. The real part and imaginary part of the transmission symbol x may be represented according to the modulation order (MOD) as the following table.

TABLE 2

| Modulation | Real part and imaginary part |
|---|---|
| order (MOD) | of transmission symbol (x) |
| QPSK | Re(x) & Im(x) ∈ {−1, 1} |
| 16QAM | Re(x) & Im(x) ∈ {−3, −1, 1, 3} |
| 64QAM | Re(x) & Im(x) ∈ {−7, −5, −3, −1, 1, 3, 5, 7} |
| 256QAM | Re(x) & Im(x) ∈ {−15, −13, . . . , 13, 15} |
| 1024QAM | Re(x) & Im(x) ∈ {−31, −29, . . . , 29, 31} |

In Table 2, it may be seen that the real part and imaginary part of the transmission symbol x are odd values having symmetry with respect to 0. The transmission symbol x, which has symmetry, may be referred to as a symmetric transmission symbol x. Hereinafter, the transmission symbol x will be referred to as a symmetric transmission symbol x.

The real part and imaginary part of the symmetric transmission symbol x, which are odd values having symmetry with respect to 0, may be represented as the following equation.

$$x = 2 \overline{x} + ( 1 + j ) \qquad [ Equation 1 ]$$

In Equation 1, x may denote a symmetric transmission symbol x, and x̅ may denote an asymmetric transmission symbol x̅. The real part and imaginary part of the asymmetric transmission symbol x̅ may be represented according to the modulation order (MOD) as the following table.

TABLE 3

| Modulation | Real part and imaginary part of asymmetric |
|---|---|
| order (MOD) | transmission symbol (x̅) |
| QPSK | Re(x) & Im(x) ∈ {−1, 0} |
| 16QAM | Re(x) & Im(x) ∈ {−2, −1, 0, 1} |
| 64QAM | Re(x) & Im(x) ∈ {−4, −3, −2, −1, 0, 1, 2, 3} |
| 256QAM | Re(x) & Im(x) ∈ {−8, −7, . . . , 6, 7} |
| 1024QAM | Re(x) & Im(x) ∈ {−16, −15, . . . , 14, 15} |

In Table 3, it may be seen that the real part and imaginary part of the asymmetric transmission symbol x̅ have asymmetry with respect to 0.

The MIMO detection circuit 210 may convert the symmetric transmission symbol x into an asymmetric transmission symbol x̅ based on Equation 1, and the bit-width of the asymmetric transmission symbol x̅ may be smaller than the bit-width of the symmetric transmission symbol x. For example, referring to Table 2 and Table 3, when the modulation order (MOD) is 1024QAM, each of the real part and the imaginary part may use 6 bits to perform an operation of the symmetric transmission symbol x, whereas the number of cases of each of the real part and imaginary part of the asymmetric transmission symbol x̅ may be 32, and the minimum (or smallest) bit-width (but-width) for representing this may be log₂ (32) and thus may be 5 bits. The MIMO detection circuit 210 may use the asymmetric transmission symbol x̅ as an input to generate a log-likelihood ratio (LLR) and may reduce the bit-width of the input, and thus, the size and power consumption of the MIMO detection circuit 210 may be reduced.

In embodiments, the MIMO detection circuit 210 may convert the symmetric transmission symbol x into an asymmetric transmission symbol x̅ by using a method other than Equation 1. For example, the MIMO detection circuit 210 may convert the symmetric transmission symbol x into an asymmetric transmission symbol x̅ such that it is not an odd value having symmetry with respect to 0. The asymmetric transmission symbol x̅ may be represented as the following table.

TABLE 4

| Modulation | Real part and imaginary part of asymmetric |
|---|---|
| order (MOD) | transmission symbol (x̅) |
| QPSK | Re(x) & Im(x) ∈ {0, 1} |
| 16QAM | Re(x) & Im(x) ∈ {−1, 0, 1, −2} |
| 64QAM | Re(x) & Im(x) ∈ {−3, −2, −1, 0, 1, 2, 3, 4} |
| 256QAM | Re(x) & Im(x) ∈ {−7, . . . , 6, 7, 8} |
| 1024QAM | Re(x) & Im(x) ∈ {−15, . . . , 14, 15, 16} |

In embodiments, the MIMO detection circuit 210 may generate an LLR based on the received reception signal vector y, the channel matrix H, and the asymmetric transmission symbol x̅ by using an algorithm (may also be referred to herein as an LLR generation algorithm). For example, the MIMO detection circuit 210 may generate an LLR by using a log MAP algorithm or a max-log MAP algorithm. The log MAP algorithm or the max-log MAP algorithm may refer to an algorithm used to provide reliability when transmitting digital information through a channel.

For example, when the MIMO detection circuit 210 generates an LLR by using the max-log MAP algorithm, it may generate an LLR by using the following equation.

$$= L ( {b}_{n , l} ) = log \frac{{max}_{\overline{x} : {b}_{n , l} = 0} {e}^{- \frac{{‖ y - H \overline{x} ‖}^{2}}{{σ}^{2}}}}{{max}_{\overline{x} : {b}_{n , l} = 1} {e}^{- \frac{{‖ y - H \overline{x} ‖}^{2}}{{σ}^{2}}}} = \frac{1}{{σ}^{2}} ( {min}_{\overline{x} : {b}_{n , l} = 1} {‖ y - H \overline{x} ‖}^{2} - {min}_{\overline{x} : {b}_{n , l} = 0} {‖ y - H \overline{x} ‖}^{2} ) \qquad [ Equation 2 ]$$

In Equation 2, b_{n,l} may denote the n-th bit value of the l-th layer, and L(b_{n,l}) may denote the LLR value of the n-th bit of the l-th layer. y may denote the reception signal vector y, H may denote the channel matrix H, and x̅ may denote an asymmetric transmission symbol vector representing a row including asymmetric transmission symbols x̅. ∥y−Hx̅∥² may denote a Euclidean distance that is the distance between the reception signal and the asymmetric transmission symbol vector.

$${min}_{\overline{x} : {b}_{n , l} = 1} {‖ y - H \overline{x} ‖}^{2}$$

may denote the minimum (or smallest) Euclidean distance when the bit value is 1, and

$${min}_{\overline{x} : {b}_{n , l} = 0} {‖ y - H \overline{x} ‖}^{2}$$

may denote the minimum (or smallest) Euclidean distance when the bit value is 0. σ may denote a noise variance. The MIMO detection circuit 210 may generate an LLR based on the reception signal vector y, the channel matrix H, and the asymmetric transmission symbol x̅ by calculating ∥y−Hx̅∥² that is the Euclidean distance.

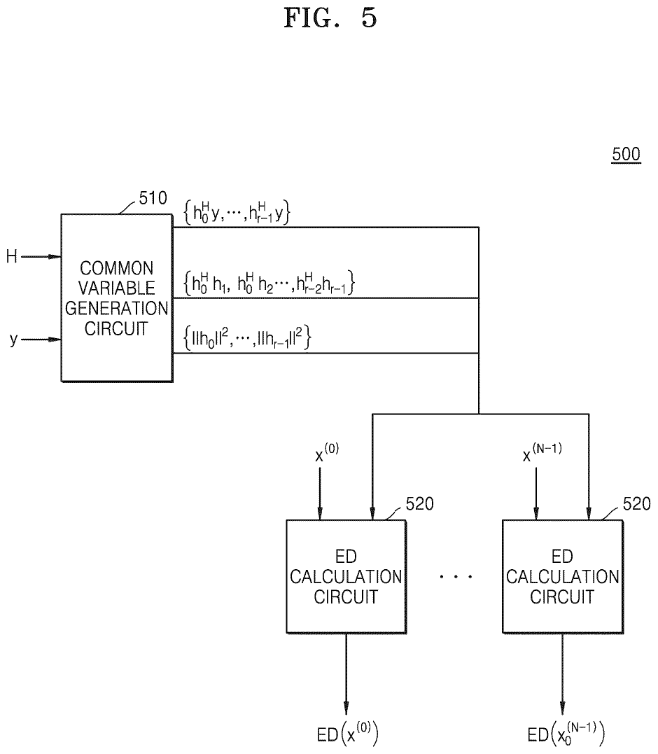

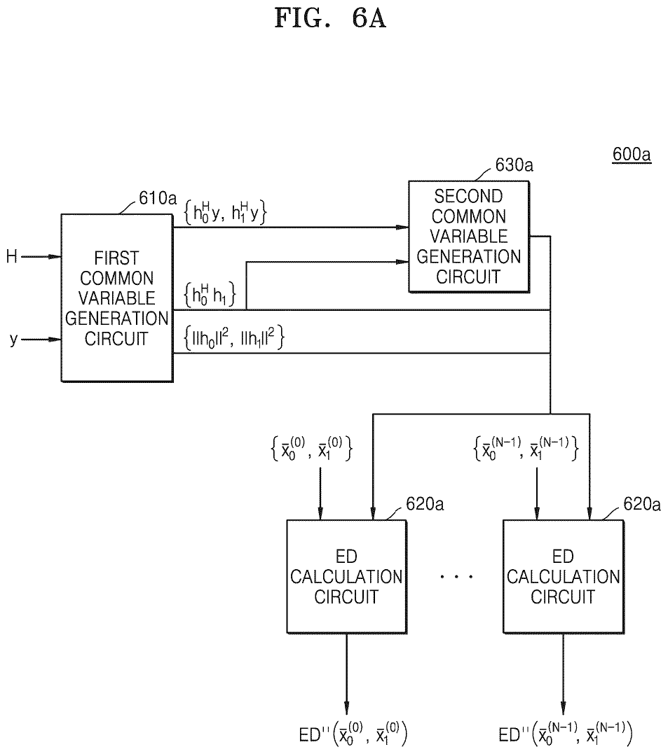

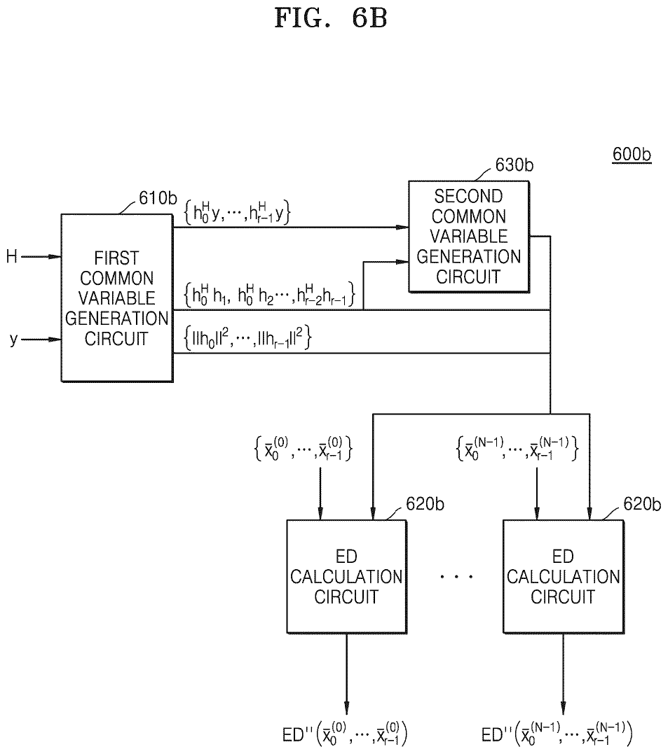

In order to solve Equation 2, the Euclidean distance for all asymmetric transmission symbols x̅ may be obtained. However, the receiving device 200 may calculate only N (N is a natural number) limited Euclidean distances by considering complexity. For example, the MIMO detection circuit 210 may select a candidate asymmetric transmission symbol among all the asymmetric transmission symbols \hat{x} by using a detection algorithm and may select N candidate asymmetric transmission symbol vectors x̅⁽ⁱ⁾ (i=0, 1, . . . , N−1) (N is a natural number) based on the candidate asymmetric transmission symbols. The detection algorithm may be a K-nearest neighbor (K-NN) algorithm that is a nonparametric method used for classification or regression. In the case of using the candidate asymmetric transmission symbol vector x̅⁽ⁱ⁾, the complexity for generating an LLR may be reduced because a calculation operation is not performed on all the asymmetric transmission symbols x̅. An example in which the MIMO detection circuit 210 calculates a Euclidean distance by using the candidate asymmetric transmission symbol vector x̅⁽ⁱ⁾ and generates an LLR based on the calculated Euclidean distance will be described below with reference to FIGS. 5, 6A and 6B.

In embodiments, when the MIMO detection circuit 210 calculates a Euclidean distance ∥y−Hx̅∥² based on the reception signal vector y, the channel matrix H, and the asymmetric transmission symbol x̅, by calculating only a term (may refer to an element in a mathematical equation as used herein, and may also be generally referred to herein as data) corresponding to the asymmetric transmission symbol x̅ (may also be referred to herein as first data), the amount of calculation required (or used) to calculate the Euclidean distance may be reduced and accordingly the power consumption of the MIMO detection circuit 210 may be reduced.

For example, referring to Equation 1, when

$${min}_{\overline{x} : {b}_{n , l} = 1} {‖ y - H \overline{x} ‖}^{2} and {min}_{\overline{x} : {b}_{n , l} = 0} {‖ y - H \overline{x} ‖}^{2}$$

are developed, a term not including the asymmetric transmission symbol \hat{x} (may also be referred to herein as second data), which is common to each of

$${min}_{\overline{x} : {b}_{n , l} = 1} {‖ y - H \overline{x} ‖}^{2} and {min}_{\overline{x} : {b}_{n , l} = 0} {‖ y - H \overline{x} ‖}^{2} ,$$

may be eliminated (or reduced) when subtracted and thus may not affect the LLR value. Thus, calculation of a term common to each of

$${min}_{\overline{x} : {b}_{n , l} = 1} {‖ y - H \overline{x} ‖}^{2} and {min}_{\overline{x} : {b}_{n , l} = 0} {‖ y - H \overline{x} ‖}^{2}$$

may be omitted.

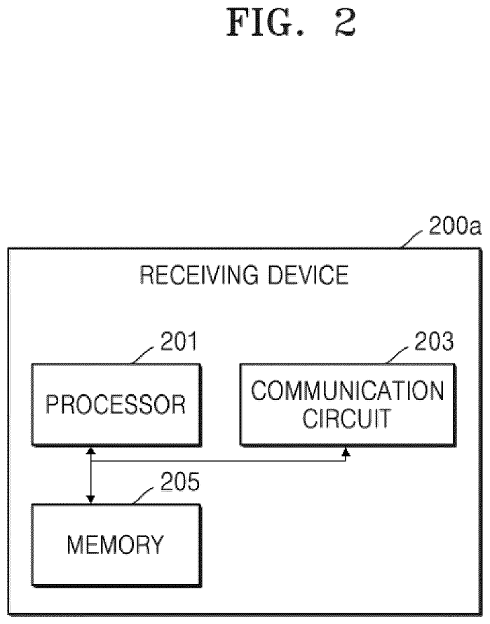

FIG. 2 is a block diagram illustrating a receiving device according to embodiments.

Referring to FIGS. 1 and 2, a receiving device 200a may include a processor 201, a communication circuit 203, and/or a memory 205. The receiving device 200a may be an example of the receiving device 200 of FIG. 1. Redundant descriptions with those of FIG. 1 will be omitted for conciseness.

The processor 201 may control the overall operations of the receiving device 200a. For example, the processor 201 may transmit and receive signals through the communication circuit 203. Also, the processor 201 may write/read data into/from the memory 205. A portion of the communication circuit 203 and the processor 201 may be referred to as a communication processor (CP).

The communication circuit 203 may perform functions for transmitting/receiving signals through wireless channels. For example, the communication circuit 203 may perform a conversion function between a baseband signal and a bit string according to the physical layer standard of the system. For example, in the case of transmitting data, the communication circuit 203 may generate complex symbols by encoding and modulating a transmission bit string, and in the case of receiving data, the communication circuit 203 may restore a reception bit string by demodulating and decoding a baseband signal. Also, the communication circuit 203 may upconvert a baseband signal into a radio frequency (RF) band signal and then transmit the same through an antenna or may downconvert an RF band signal received through an antenna into a baseband signal. For example, the communication circuit 203 may include a transmission filter, a reception filter, an amplifier, a mixer, an oscillator, a digital-to-analog converter (DAC), an analog-to-digital converter (ADC), and/or the like. The communication circuit 203 may perform beamforming. The communication circuit 203 may apply beamforming weights to signals to give directionality to signals to be transmitted/received. In embodiments, the communication circuit 203 may receive a spatially-multiplexed MIMO signal through the MIMO detection circuit 210 and obtain an error-corrected bit string through the decoder 220. According to embodiments, after recovering the error-corrected bit string, the receiving device 200a may perform one or more further operation(s) based on the error-corrected bit string. For example, the one or more further operation(s) may include one or more of providing the error-corrected bit string to an application executing on (e.g., stored in the memory 205 and executed by the processor 201) the receiving device 200a (e.g., for performing a service based on data provided in the serially converted signals), storing the error-corrected bit string (e.g., in the memory 205), sending a response signal to the transmitting device 100 (e.g., using the same components as, or similar components to, those of the transmitting device 100 discussed in connection with FIG. 1) based on data provided in the error-corrected bit string, etc.

The memory 205 may store data such as a basic program, an application program, or configuration information for operation of the receiving device 200. The memory 205 may include a volatile memory, a nonvolatile memory, or a combination of a volatile memory and a nonvolatile memory. The memory 205 may provide stored data at the request of the processor 201.

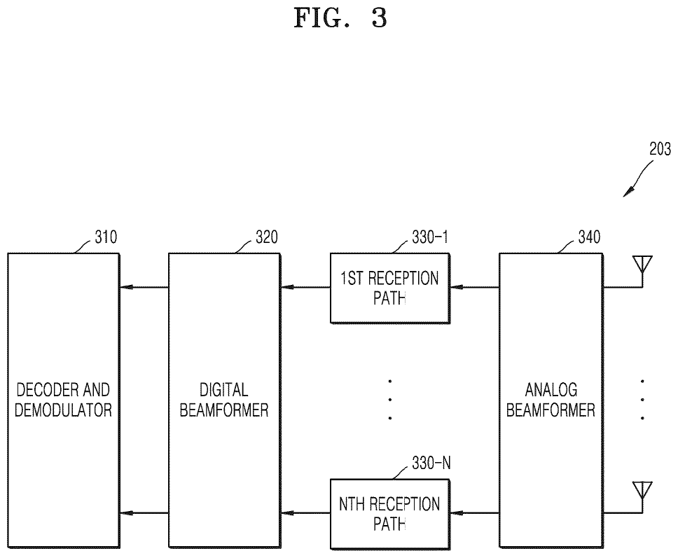

FIG. 3 is a block diagram illustrating a communication circuit according to embodiments.

Referring to FIG. 3, the communication circuit 203 may include a decoder and demodulator 310, a digital beamformer 320, a first reception path 330-1 to an Nth reception path 330-N, and/or an analog beamformer 340.

According to embodiments, the decoder and demodulator 310 may perform channel decoding. For channel decoding, at least one of low density parity check (LDPC) code, convolution code, polar code, and/or turbo code may be used. For example, the decoder and demodulator 310 may correspond to the decoder 220 of the receiving device 200 in FIG. 1.

The digital beamformer 320 may multiply analog signals received through the first reception path 330-1 to the Nth reception path 330-N by beamforming weights. Here, the beamforming weights may be used to change the size and/or phase of signals. In this case, modulation symbols multiplexed according to a MIMO transmission scheme may be received through the first reception path 330-1 to the Nth reception path 330-N.

The analog beamformer 440 may perform beamforming on analog signals. The analog beamformer 440 may perform beamforming on an analog reception beam to receive a MIMO signal.

Each of the first reception path 330-1 to the Nth reception path 330-N may include a fast Fourier transform (FFT) operator, an ADC, a cyclic prefix (CP) remover, a serial-to-parallel converter, and/or a downconverter. Each of the first reception path 330-1 to the Nth reception path 330-N may downconvert a received signal to a baseband frequency, generate a serial time-domain baseband signal by removing a CP, convert a serial time-domain baseband signal into parallel time-domain signals, generate N parallel frequency-domain signals by performing an FFT algorithm, and convert parallel frequency-domain signals into a sequence of modulated data symbols. That is, the first reception path 330-1 to the Nth reception path 330-N may provide an independent signal processing process for a plurality of streams generated through digital beamforming. However, according to an implementation method, some of the components of the first reception path 330-1 to the Nth reception path 330-N may be commonly used (e.g., by each among the first reception path 330-1 to the Nth reception path 330-N).

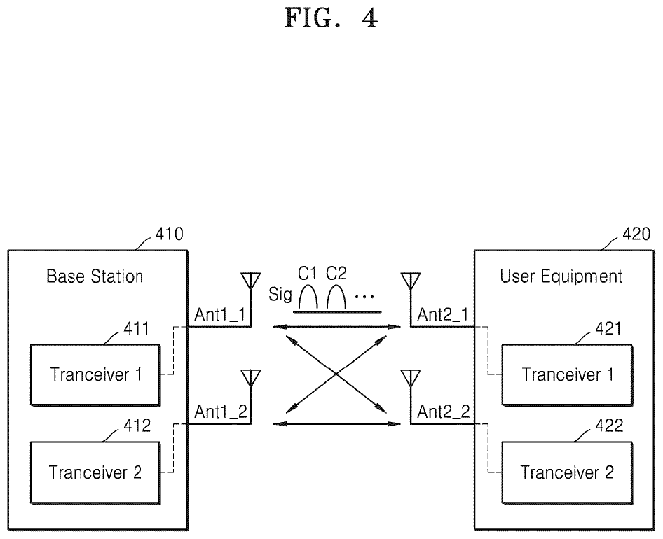

FIG. 4 is a block diagram illustrating a MIMO environment according to embodiments.

Referring to FIG. 4, a base station 410 and a user equipment 420 may communicate with each other by using a MIMO method. For this purpose, each of the base station 410 and the user equipment 420 may include a plurality of antennas (Ant1_1, Ant1_2, Ant2_1, and Ant2_2). FIG. 4 illustrates that each of the base station 410 and the user equipment 420 includes two antennas (Ant1_1, Ant1_2, Ant2_1, and Ant2_2); however, the inventive concepts are not limited thereto. The inventive concepts may also be applied to embodiments in which each of the base station 410 and the user equipment 420 include three or more antennas.

The base station 410 may include a first transceiver 411, a second transceiver 412, a first antenna Ant1_1, and/or a second antenna Ant1_2. Each of the first transceiver 411 and the second transceiver 412 may be connected to one antenna (e.g., only one antenna). For example, the first transceiver 411 may be connected to the first antenna Ant1_1 and the second transceiver 412 may be connected to the second antenna Ant1_2. When the base station 410 operates as a transmitting device, the first transceiver 411 and the second transceiver 412 may operate as a transmitter, and when the base station 410 operates as a receiving device, the first transceiver 411 and the second transceiver 412 may operate as a receiver.

In a transmission mode, the first transceiver 411 may generate a first signal Sig by merging a first component carrier signal C1 and a second component signal C2, and output the generated first signal Sig to the user equipment 420. The first transceiver 411 may extract not only the first component carrier signal C1 but also the second component signal C2 from the first signal Sig. Each of the first transceiver 411 and the second transceiver 412 may merge and transmit a plurality of component carrier signals instead of transmitting only one component carrier signal, and may extract a plurality of component carrier signals instead of extracting only one component carrier signal from the first signal Sig. The user equipment 420 may include a third transceiver 421, a fourth transceiver 422, a third antenna Ant2_1, and/or a fourth antenna Ant2_2. Because the user equipment 420 may be substantially the same as or similar to the base station 410, redundant descriptions thereof will be omitted for conciseness.

FIG. 5 is a block diagram illustrating a MIMO detection circuit according to a comparative example.

Referring to FIG. 5, a MIMO detection circuit 500 may calculate a Euclidean distance based on a reception signal vector y, a channel matrix H, and a candidate symmetric transmission symbol vector x⁽ⁱ⁾. The reception signal vector y and the channel matrix H may be the same as (or similar to) the reception signal vector y and the channel matrix H described above with reference to FIG. 1. The MIMO detection circuit 500 may select candidate symmetric transmission symbols among the symmetric transmission symbols (x) described above with reference to FIG. 1 by considering complexity, and may select N candidate symmetric transmission symbol vectors x⁽ⁱ⁾ (i=0, 1, . . . , N−1) (N is a natural number) based on the candidate symmetric transmission symbols and calculate only N limited Euclidean distances. The candidate symmetric transmission symbol vector x⁽ⁱ⁾ may be a vector representing a row including candidate symmetric transmission symbols and may be represented as the following equation.

$${x}^{( i )} := [ {x}_{0}^{( i )} , … , {x}_{r - 1}^{( i )} ] \qquad [ Equation 3 ]$$

In Equation 3, r may denote a rank. xₜ⁽ⁱ⁾ may be a candidate symmetric transmission symbol of rank t+1. By using Equation 3, a Euclidean distance for N transmission symbol vectors may be represented as the following equation.

$$ED ( {x}^{( i )} ) = {‖ y - {h}_{0} {x}_{0}^{( i )} … - {h}_{r - 1} {x}_{r - 1}^{( i )} ‖}^{2} \qquad [ Equation 4 ]$$

In Equation 4, hⱼ may denote a j-th column of the channel matrix H and ED(x⁽ⁱ⁾) may denote a Euclidean distance for the candidate symmetric transmission symbol vector x⁽ⁱ⁾. Equation 4 is simplified assuming that the rank is 2 and may be represented as the following equation. According to embodiments, “j” may represent an imaginary number.

$$ED ( {x}^{( i )} ) = {‖ y ‖}^{2} + {‖ {h}_{0} ‖}^{2} \cdot {\vert {x}_{0}^{( i )} \vert}^{2} + {‖ {h}_{1} ‖}^{2} \cdot {\vert {x}_{1}^{( i )} \vert}^{2} - 2 Re ( {h}_{0}^{H} y \cdot {x}_{0}^{{( i )}^{*}} ) - 2 Re ( ( {h}_{1}^{H} y - {h}_{0}^{H} {h}_{1} \cdot {x}_{0}^{{( i )}^{*}} ) \cdot {x}_{1}^{( i )} ) \qquad [ Equation 5 ]$$

In Equation 5, a particular value irrelevant to “i” may not affect the LLR value, and therefore, Equation 5 may be represented as the following equation.

$${ED}^{′} ( x ) = {‖ {h}_{0} ‖}^{2} \cdot ( {\vert {x}_{0} \vert}^{2} - 2 ) + {‖ {h}_{1} ‖}^{2} \cdot ( {\vert {x}_{1} \vert}^{2} - 2 ) - 2 Re ( {h}_{0}^{H} y \cdot {x}_{0}^{*} ) - 2 Re ( ( {h}_{1}^{H} y + {h}_{1}^{H} {h}_{0} \cdot {x}_{0} ) \cdot {x}_{1}^{*} ) \qquad [ Equation 6 ]$$

In Equation 6, ED′(x) may denote a modified Euclidean distance of ED(x⁽ⁱ⁾) of Equation 5. |x|²−2 may be represented as (|Re(x)|²−1)+(|Im(x)|²−1), and referring to Table 3 of FIG. 1, it may be seen that each of both (|Re(x)|²−1) and (|Im(x)|²−1) is a multiple of 8. Accordingly, when each of the (|Re(x)|²−1)/8 value and (|Im(x)|₂−1)/8 is obtained based on an operation or table and then a left shift (<<3) operation is performed thereon, Equation 6 may be represented as the following equation.

$${ED}^{′} ( x ) = 2 ( 4 \cdot {‖ {h}_{0} ‖}^{2} \cdot \frac{( {\vert {x}_{0} \vert}^{2} - 2 )}{8} + 4 \cdot {‖ {h}_{1} ‖}^{2} \cdot \frac{( {\vert {x}_{1} \vert}^{2} - 2 )}{8} - Re ( {h}_{0}^{H} y \cdot {x}_{0}^{*} ) - Re ( ( {h}_{1}^{H} y - {h}_{1}^{H} {h}_{0} \cdot {x}_{0} ) \cdot {x}_{1}^{*} ) ) \qquad [ Equation 7 ]$$

In other words, the Euclidean distance may be represented as a multiple of 2.

In contrast, the MIMO detection circuit of the inventive concepts (e.g., the MIMO detection circuit 210 of FIG. 1) may calculate a Euclidean distance based on the asymmetric transmission symbol x̅, and the Euclidean distance calculated based on the asymmetric transmission symbol x̅ may be represented as a multiple of 4.

In embodiments, referring to Equation 1 of FIG. 1, the candidate asymmetric transmission symbol x̅ᵢ of FIG. 1 may be represented as the following equation.

$${x}_{i} = 2 {\overline{x}}_{i} + ( 1 + j ) , i = 0 , … , r - 1 \qquad [ Equation 8 ]$$

In Equation 8, xᵢ may denote r (“r” is a natural number) candidate symmetric transmission symbols xᵢ, and x̅ᵢ may denote r candidate asymmetric transmission symbols x̅ᵢ. When only the other terms irrelevant to |xᵢ|² are represented with respect to Equation 6 by using Equation 8, the other terms may be represented in the following equation.

$${ED}_{R} = - 2 Re ( {h}_{0}^{H} y \cdot ( {( 2 {\overline{x}}_{0} + ( 1 + j ) )}^{*} ) ) - 2 Re ( ( {h}_{1}^{H} y - {h}_{1}^{H} {h}_{0} \cdot ( 2 {\overline{x}}_{0} + ( 1 + j ) ) ) \cdot {( 2 {\overline{x}}_{1} + ( 1 + j ) )}^{*} ) = - 2 Re ( {h}_{0}^{H} y \cdot ( {( 2 {\overline{x}}_{0} + ( 1 + j ) )}^{*} ) ) - 2 Re ( ( {h}_{1}^{H} y - 2 {h}_{1}^{H} {h}_{0} \cdot {\overline{x}}_{0} ) \cdot {( 2 {\overline{x}}_{1} + ( 1 + j ) )}^{*} ) + 2 Re ( {h}_{1}^{H} {h}_{0} \cdot ( 1 + j ) \cdot {( 1 + j )}^{*} + 2 {h}_{1}^{H} {h}_{0} \cdot {\overline{x}}_{1}^{*} \cdot ( 1 + j ) ) \qquad [ Equation 9 ]$$

In Equation 9, ED_{R} may denote a modified Euclidean distance of ED′(x) of Equation 6. h₁^{H}h₀·(1+j)·(1+j)*, which is a common term irrelevant to x̅ᵢ, may not affect the LLR value and thus may be omitted, which may be represented in the following equation.

$${ED}_{R} = - 2 Re ( {h}_{0}^{H} y \cdot ( {( 2 {\overline{x}}_{0} + ( 1 + j ) )}^{*} ) ) - 2 Re ( ( {h}_{1}^{H} y - 2 {h}_{1}^{H} {h}_{0} \cdot {\overline{x}}_{0} ) \cdot {( 2 {\overline{x}}_{1} + ( 1 + j ) )}^{*} ) + 4 Re ( {h}_{1}^{H} {h}_{0} \cdot {\overline{x}}_{1}^{*} \cdot ( 1 + j ) ) = - 4 Re ( {h}_{0}^{H} y \cdot {\overline{x}}_{0}^{*} ) - 4 Re ( ( {h}_{1}^{H} y - 2 \cdot {h}_{1}^{H} {h}_{0} \cdot {\overline{x}}_{0} ) \cdot {\overline{x}}_{1}^{*} ) + 4 Re ( {h}_{1}^{H} {h}_{0} \cdot {\overline{x}}_{1}^{*} \cdot ( 1 + j ) ) - 2 Re ( {h}_{0}^{H} y \cdot {( 1 + j )}^{*} ) - 2 Re ( {h}_{1}^{H} y \cdot {( 1 + j )}^{*} ) + 4 Re ( {h}_{1}^{H} {h}_{0} \cdot {\overline{x}}_{0} \cdot {( 1 + j )}^{*} ) \qquad [ Equation 10 ]$$

Like in Equation 9, in Equation 10, because −2Re(h₀^{H}y·(1+j)*)−2Re(h₁^{H}y·(1+j)*) is a common term irrelevant to x̅ᵢ, it may not affect the LLR value and thus may be omitted, and by using the Re(α)=Re(α*) relationship, Equation 10 may be represented as the following equation.

$${ED}^{″} ( x ) = 8 \cdot {‖ {h}_{0} ‖}^{2} \cdot \frac{( {\vert {x}_{0} \vert}^{2} - 2 )}{8} + 8 \cdot {‖ {h}_{1} ‖}^{2} \cdot \frac{( {\vert {x}_{1} \vert}^{2} - 2 )}{8} - 4 Re ( ( {h}_{0}^{H} y - {h}_{0}^{H} {h}_{1} \cdot ( 1 + j ) ) \cdot {\overline{x}}_{0}^{*} ) - 4 Re ( ( {h}_{1}^{H} y - {h}_{1}^{H} {h}_{0} \cdot ( 1 + j ) - 2 \cdot {h}_{1}^{H} {h}_{0} \cdot {\overline{x}}_{0} ) \cdot {\overline{x}}_{1}^{*} ) = 4 ( 2 \cdot {‖ {h}_{0} ‖}^{2} \cdot \frac{( {\vert {x}_{0} \vert}^{2} - 2 )}{8} + 2 \cdot {‖ {h}_{1} ‖}^{2} \cdot \frac{( {\vert {x}_{1} \vert}^{2} - 2 )}{8} - Re ( ( {h}_{0}^{H} y - {h}_{0}^{H} {h}_{1} \cdot ( 1 + j ) ) \cdot {\overline{x}}_{0}^{*} ) - Re ( ( {h}_{1}^{H} y - {h}_{1}^{H} {h}_{0} \cdot ( 1 + j ) - 2 \cdot {h}_{1}^{H} {h}_{0} \cdot {\overline{x}}_{0} ) \cdot {\overline{x}}_{1}^{*} ) ) \qquad [ Equation 11 ]$$

In Equation 11, ED″(x) may denote a modified Euclidean distance of ED_{R} of Equation 10. ED″(x) may be represented as a multiple of 4. In other words, while the MIMO detection circuit 500 according to the comparative example may represent the Euclidean distance as a multiple of 2, the MIMO detection circuit of the inventive concepts (e.g., the MIMO detection circuit 210 of FIG. 1) may represent the Euclidean distance as a multiple of 4 and thus the bit-width of the Euclidean distance may be reduced by 1 bit. Accordingly, compared to the comparative example, the size of hardware (e.g., MIMO detection circuit) may be reduced, thus allowing implementation with lower hardware complexity and reduction of hardware power consumption.

The MIMO detection circuit 500 may include a common variable generation circuit 510 and a plurality of Euclidean distance (ED) calculation circuits 520. The common variable generation circuit 510 may receive a reception signal vector y and a channel matrix H and generate a common variable based on the reception signal vector y and the channel matrix H. The common variable may refer to a variable commonly applied to all x⁽ⁱ⁾ in Equation 5. The common variable may include {h₀^{H}y, . . . , hᵣ₋₁^{H}y}, {h₀^{H}h₁, h₀^{H}h₂, . . . , hᵣ₋₂^{H}hᵣ₋₁} and/or {∥h₀∥², . . . , ∥hᵣ₋₁∥²}.

The ED calculation circuits 520 may receive the common variable from the common variable generation circuit 510 and calculate ED(x⁽ⁱ⁾) of Equation 5 based on the common variable and the candidate symmetric transmission symbol vector x⁽ⁱ⁾. ED(x⁽ⁱ⁾) of Equation 5 may be calculated by the operation of the common variable and x⁽ⁱ⁾.

FIGS. 6A and 6B are block diagrams illustrating a MIMO detection circuit according to embodiments.

Referring to FIGS. 1, 6A, and 6B, a MIMO detection circuit 600a or 600b may be an example of the MIMO detection circuit 210 of FIG. 1, and thus, redundant descriptions with those of FIG. 1 will be omitted for conciseness.

The MIMO detection circuit 600a may be an example for simply describing a process of calculating a Euclidean distance by the MIMO detection circuit 600b, and the MIMO detection circuit 600a may calculate a Euclidean distance, assuming that a rank is 2. The MIMO detection circuit 600b may calculate a Euclidean distance for a certain rank.

The MIMO detection circuit 600a or 600b may calculate a Euclidean distance based on a reception signal vector y, a channel matrix H, and a candidate symmetric transmission symbol vector x̅⁽ⁱ⁾. The reception signal vector y and the channel matrix H may be the same as (or similar to) the reception signal vector y and the channel matrix H described above with reference to FIG. 1, and the candidate asymmetric transmission symbol vector x̅⁽ⁱ⁾ (i=0, 1, . . . , N−1) (N is a natural number) may be the same as (or similar to) the candidate asymmetric transmission symbol vector x̅ᵢ according to Equation 8 of FIG. 5.

The MIMO detection circuit 600a may include a first common variable generation circuit 610a, a second common variable generation circuit 630a, and/or a plurality of ED calculation circuits 620a. The first common variable generation circuit 610a may receive a reception signal vector y and a channel matrix H, and generate a first common variable based on the reception signal vector y and the channel matrix H. The first common variable may refer to a variable commonly applied to all x̅⁽ⁱ⁾ in Equation 9 of FIG. 5. The first common variable may include {h₀^{H}y, h₁^{H}y}, {h₀^{H}h₁}, and/or {∥h₀∥², ∥h₁∥²}.

The second common variable generation circuit 630a may generate a second common variable based on the first common variable. The second common variable may refer to a variable that is generated based on the first common variable and may be precalculated (or calculated) regardless of x̅⁽ⁱ⁾ in Equation 11 of FIG. 5. For example, the second common variable may include (h₀^{H}y−h₀^{H}h₁·(1+j)) and/or h₁^{H}y−h₁^{H}h₀·(1+j) in Equation 11 of FIG. 5.

The ED calculation circuits 620a may receive the first common variable and the second common variable from the first common variable generation circuit 610a and the second common variable generation circuit 630a, and may calculate ED″(x) of Equation 11 of FIG. 5 based on the first common variable, the second common variable, and the candidate asymmetric transmission symbol vector x̅⁽ⁱ⁾ ED″(x) of Equation 11 of FIG. 5 may be calculated by the operation of the first common variable, the second common variable, and x̅⁽ⁱ⁾.

The MIMO detection circuit 600b may include a first common variable generation circuit 610b, a second common variable generation circuit 630b, and/or a plurality of ED calculation circuits 620b, which may be respectively the same as (or similar to) the first common variable generation circuit 610a, the second common variable generation circuit 630a, and/or the plurality of ED calculation circuits 620a and thus redundant descriptions thereof will be omitted for conciseness.

Because the MIMO detection circuit 600a or 600b may precalculate (or calculate) and receive a variable, which may be precalculated (or calculated) regardless of x̅⁽ⁱ⁾, from the second common variable generation circuit 630a or 630b, the amount of calculation may be reduced compared to performing calculation including the second common variable in each of the plurality of ED calculation circuits 620a or 620b, and accordingly, the size of the MIMO detection circuit 600a or 600b may be reduced, thus allowing implementation of the MIMO detection circuit 600a or 600b with lower complexity and reduction of the power consumption of the MIMO detection circuit 600a or 600b.

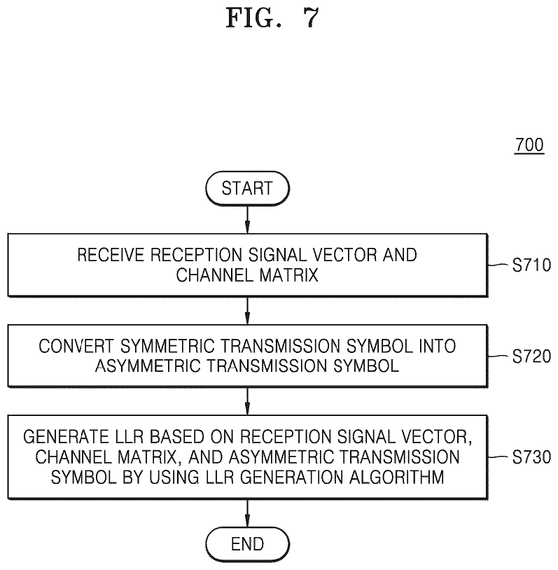

FIG. 7 is a flowchart illustrating an LLR generation method in a MIMO system according to embodiments. As illustrated in FIG. 7, an LLR generation method 700 in the MIMO system may include a plurality of operations S710 to S730.

Referring to FIGS. 1 and 7, in operation S710, the MIMO detection circuit 210 may receive a reception signal vector y and a channel matrix H. In embodiments, the MIMO detection circuit 210 may receive the reception signal vector y through the receiver 230 and may receive the channel matrix H estimated by the channel estimator 240 from the channel estimator 240.

In operation S720, the MIMO detection circuit 210 may convert a symmetric transmission symbol into an asymmetric transmission symbol. In embodiments, in the 3GPP release, the transmission symbol vector may include a real part and an imaginary part that are odd values having symmetry with respect to 0 according to the modulation order (MOD), which may be referred to as a symmetric transmission symbol x. The MIMO detection circuit 210 may convert the symmetric transmission symbol x into an asymmetric transmission symbol x̅ such that it is not an odd value having symmetry with respect to 0. For example, based on Equation 1 of FIG. 1, the symmetric transmission symbol x may be converted into an asymmetric transmission symbol x̅.

In operation S730, the MIMO detection circuit 210 may generate an LLR based on the reception signal vector y, the channel matrix H, and the asymmetric transmission symbol x̅ by using an LLR generation algorithm.

In embodiments, the MIMO detection circuit 210 may generate an LLR by using a log MAP algorithm or a max-log MAP algorithm. The log MAP algorithm or the max-log MAP algorithm may refer to an algorithm used to provide reliability when transmitting digital information through a channel. For example, when the MIMO detection circuit 210 generates an LLR by using the max-log MAP algorithm, it may generate an LLR by using Equation 1 of FIG. 1.

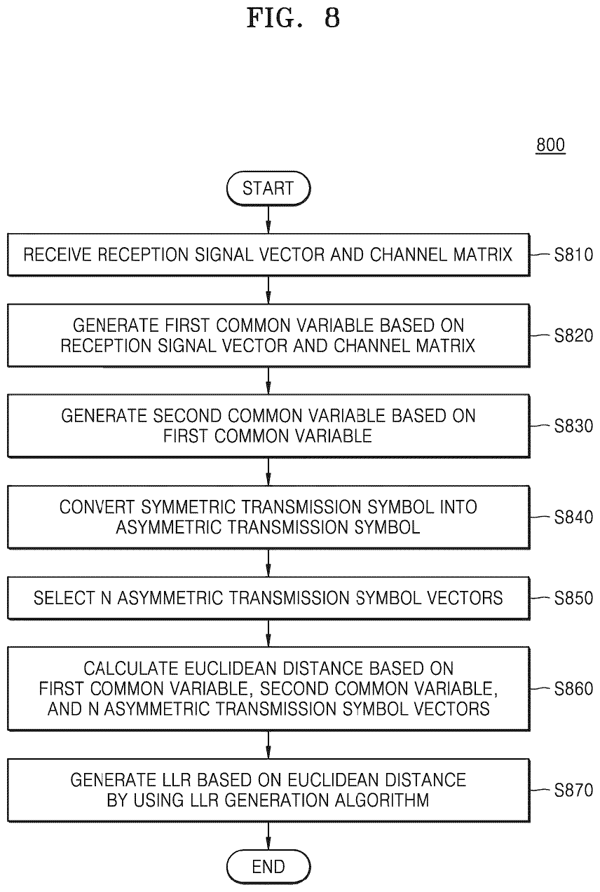

FIG. 8 is a flowchart illustrating an LLR generation method in a MIMO system according to embodiments. As illustrated in FIG. 8, an LLR generation method 800 in the MIMO system may include a plurality of operations S810 to S870.

Referring to FIGS. 1, 6B, and 8, in operation S810, the first common variable generation circuit 610b may receive a reception signal vector y and a channel matrix H. In embodiments, the first common variable generation circuit 610b may receive the reception signal vector y through the receiver 230 and may receive the channel matrix H estimated by the channel estimator 240 from the channel estimator 240.

In operation S820, the first common variable generation circuit 610b may generate a first common variable based on the reception signal vector y and the channel matrix H. In embodiments, the first common variable may refer to a variable commonly applied to all x̅⁽ⁱ⁾ in Equation 9 of FIG. 5. The first common variable may include {h₀^{H}y, . . . , hᵣ₋₁^{H}y}, {h₀^{H}h₁, h₀^{H}h₂ . . . , hᵣ₋₂^{H}hᵣ₋₁}, and/or {∥h₀∥², . . . , ∥hᵣ₋₁∥²}.

In operation S830, the second common variable generation circuit 630b may generate a second common variable based on the first common variable. In embodiments, the second common variable may refer to a variable that is generated based on the first common variable and may be precalculated (or calculated) regardless of x̅⁽ⁱ⁾ in Equation 11 of FIG. 5. For example, the second common variable may be generated based on {h₀^{H}y, . . . , hᵣ₋₁y} and/or {h₀^{H}h₁, h₀^{H}h₂ . . . , hᵣ₋₂^{H}hᵣ₋₁}.

In operation S840, the MIMO detection circuit 600b may convert a symmetric transmission symbol into an asymmetric transmission symbol. In embodiments, in the 3GPP release, the transmission symbol vector may include a real part and an imaginary part that are odd values having symmetry with respect to 0 according to the modulation order (MOD), which may be referred to as a symmetric transmission symbol x. The MIMO detection circuit 210 may convert the symmetric transmission symbol x into an asymmetric transmission symbol x̅ such that it is not an odd value having symmetry with respect to 0. For example, based on Equation 1 of FIG. 1, the symmetric transmission symbol x may be converted into an asymmetric transmission symbol x̅.

In operation S850, the MIMO detection circuit 600b may select N (N is a natural number) candidate asymmetric transmission symbol vectors x̅⁽ⁱ⁾ (i=0, 1, . . . , N−1) based on the asymmetric transmission symbol x̅. In embodiments, by using a detection algorithm such as a K-nearest neighbor (K-NN) algorithm that is a nonparametric method used for classification or regression, the MIMO detection circuit 600b may select candidate asymmetric transmission symbols among all asymmetric transmission symbols x̅ and may select N candidate asymmetric transmission symbol vectors x̅⁽ⁱ⁾ based on the candidate asymmetric transmission symbols. The candidate asymmetric transmission symbol vector x̅⁽ⁱ⁾ may be a vector representing a row including candidate asymmetric transmission symbols.

In operation S860, the MIMO detection circuit 600b may calculate a Euclidean distance based on the first common variable, the second common variable, and the N candidate asymmetric transmission symbol vectors x̅⁽ⁱ⁾. In embodiments, the plurality of ED calculation circuits 620b may receive the first common variable, the second common variable, and the N candidate asymmetric transmission symbol vectors x̅⁽ⁱ⁾ as an input, and calculate ED″(x̅₀^{(N-1)}, . . . , x̅ᵣ₋₁^{(N-1)}) that is the Euclidean distance, based on Equation 11 of FIG. 5.

In operation S870, the MIMO detection circuit 600b may generate an LLR based on the Euclidean distance by using an LLR generation algorithm. In embodiments, by using a max-log MAP algorithm, the MIMO detection circuit 600b may generate an LLR by substituting ED″(x₀^{(N-1)}, . . . , x̅ᵣ₋₁^{(N-1)}) calculated by the plurality of ED calculation circuits 620b into Equation 2 of FIG. 1.

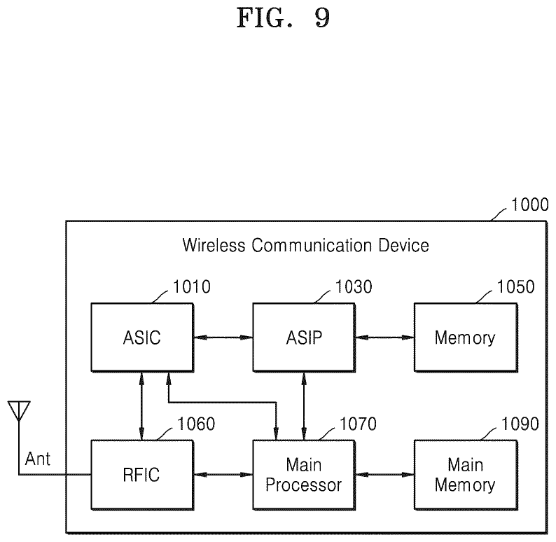

FIG. 9 is a block diagram illustrating a wireless communication device according to embodiments.

Referring to FIG. 9, a wireless communication device 1000 may include a modem (not illustrated) and a radio frequency integrated circuit (RFIC) 1060, and the modem may include an application specific integrated circuit (ASIC) 1010, an application specific instruction set processor (ASIP) 1030, a memory 1050, a main processor 1070, and/or a main memory 1090.

The wireless communication device 1000 of FIG. 9 may include a MIMO detection circuit (e.g., the MIMO detection circuit 210 of FIG. 1) (not illustrated) according to embodiments. The MIMO detection circuit may calculate a Euclidean distance based on an asymmetric transmission symbol with a relatively small bit-width, and thus, the bit-width of the Euclidean distance may be reduced. Accordingly, the size of the wireless communication device 1000 may be reduced, and thus, the wireless communication device 1000 may be implemented with lower complexity and the power consumption of the wireless communication device 1000 may be reduced.

The RFIC 1060 may be connected to an antenna Ant to receive/transmit signals from/to the outside by using a wireless communication network. As an integrated circuit customized for a particular purpose, the ASIP 1030 may support a dedicated instruction set for a particular application and may execute instructions included in an instruction set. The memory 1050 may communicate with the ASIP 1030 and, as a non-transitory storage device, may store a plurality of instructions executed by the ASIP 1030. For example, the memory 1050 may include, but is not limited to, any type of memory accessible by the ASIP 1030, such as random access memories (RAMs), read only memories (ROMs), tapes, magnetic disks, optical disks, volatile memories, nonvolatile memories, or any combination thereof.

The main processor 1070 may control the wireless communication device 1000 by executing a plurality of instructions. For example, the main processor 1070 may control the ASIC 1010 and/or the ASIP 1030, process data received through a wireless communication network, or process a user input to the wireless communication device 1000.

The main memory 1090 may communicate with the main processor 1070 and, as a non-transitory storage device, may store a plurality of instructions executed by the main processor 1070. For example, the main memory 1090 may include, but is not limited to, any type of memory accessible by the main processor 1070, such as RAMs, ROMs, tapes, magnetic disks, optical disks, volatile memories, nonvolatile memories, or any combination thereof.

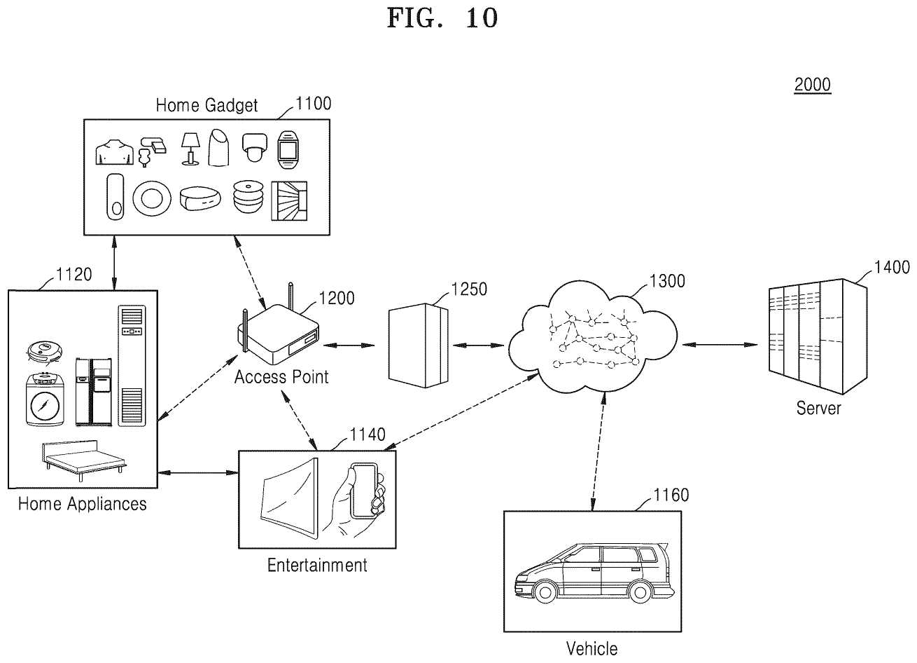

FIG. 10 is a conceptual diagram illustrating an IoT network system according to embodiments.

Referring to FIG. 10, an IoT network system 2000 may include a plurality of IoT equipments 1100, 1120, 1140, and/or 1160, an access point 1200, a gateway 1250, a wireless network 1300, and/or a server 1400. The IoT may refer to a network between things using wired/wireless communication.

Each of the IoT equipments 1100, 1120, 1140, and 1160 may form a group according to the characteristics of each IoT equipment. For example, the IoT equipments 1100, 1120, 1140, and 1160 may be grouped into a home gadget group 1100, a home appliance/furniture group 1120, an entertainment group 1140, a vehicle group 1160, or the like. A plurality of IoT equipments 1100, 1120, and 1140 may be connected to a communication network or to another IoT equipment through the access point 1200. The access point 1200 may be built in one IoT equipment. The gateway 1250 may change the protocol to connect the access point 1200 to an external wireless network. The IoT equipments 1100, 1120, and 1140 may be connected to an external communication network through the gateway 1250. The wireless network 1300 may include the Internet and/or a public network. The plurality of IoT equipments 1100, 1120, 1140, and 1160 may be connected through the wireless network 1300 to the server 1400 providing a certain service, and the user may use a service through at least one of the plurality of IoT equipments 1100, 1120, 1140, and 1160.

According to embodiments, each (or any) of the plurality of IoT equipments 1100, 1120, 1140, and 1160 may include a MIMO detection circuit (not illustrated) described above with reference to FIGS. 1 to 8 (e.g., the MIMO detection circuit 210 of FIG. 1). The MIMO detection circuit may calculate a Euclidean distance based on an asymmetric transmission symbol with a relatively small bit-width, and thus, the bit-width of the Euclidean distance may be reduced. Accordingly, the size of the plurality of IoT equipments 1100, 1120, 1140, and 1160 may be reduced, and thus, the plurality of IoT equipments 1100, 1120, 1140, and 1160 may be implemented with lower complexity and the power consumption of the plurality of IoT equipments 1100, 1120, 1140, and 1160 may be reduced.

Conventional devices and methods for performing MIMO communication perform symbol detection on symmetric symbols included in received signals. However, as modulation orders and ranks of the received signals increase, calculations performed by the conventional devices and methods to perform the symbol detection become increasingly complex. The hardware used by the conventional devices and methods address this increased complexity has an excessively large physical size and complexity, and consumes excessive resources (e.g., power consumption) in performing the symbol detection calculations.

However, according to embodiments, improved devices and methods are provided for performing MIMO communication. For example, the improved devices and methods may convert the symmetric symbols included in received signals to asymmetric symbols. The asymmetric symbols may have smaller bit-widths than those of the symmetric symbols. Accordingly, the improved devices and methods may perform symbol detection using calculations (e.g., calculating Euclidean distances) of smaller bit-widths than those used in the calculations performed by the conventional devices and methods. Therefore, the improved devices and methods overcome the deficiencies of the conventional devices and methods to at least reduce hardware physical size and/or complexity, and/or reduce resource consumption (e.g., power consumption).

According to embodiments, operations described herein as being performed by the wireless communication system 10, the transmitting device 100, the receiving device 200, the encoder 110, the deserializer 120, the MIMO detection circuit 210, the decoder 220, the receiver 230, the channel estimator 240, the receiving device 200a, the processor 201, the communication circuit 203, the decoder and demodulator 310, the digital beamformer 320, each among the first reception path 330-1 to the Nth reception path 330-N, the analog beamformer 340, the base station 410, the user equipment 420, the first transceiver 411, the second transceiver 412, the third transceiver 421, the fourth transceiver 422, the MIMO detection circuit 500, the common variable generation circuit 510, each among the plurality of Euclidean distance (ED) calculation circuits 520, the MIMO detection circuit 600a, the first common variable generation circuit 610a, the second common variable generation circuit 630a, each among the plurality of ED calculation circuits 620a, the MIMO detection circuit 600b, the first common variable generation circuit 610b, the second common variable generation circuit 630b, each among the plurality of ED calculation circuits 620b, the wireless communication device 1000, the RFIC 1060, the ASIC 1010, the ASIP 1030, the main processor 1070, the IoT network system 2000, each among the plurality of IoT equipments 1100, 1120, 1140, and/or 1160, the access point 1200, the gateway 1250 and/or the server 1400 may be performed by processing circuitry. The term ‘processing circuitry,’ as used in the present disclosure, may refer to, for example, hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc.

The various operations of methods described above may be performed by any suitable device capable of performing the operations, such as the processing circuitry discussed above. For example, as discussed above, the operations of methods described above may be performed by various hardware and/or software implemented in some form of hardware (e.g., processor, ASIC, etc.).

The software may comprise an ordered listing of executable instructions for implementing logical functions, and may be embodied in any “processor-readable medium” for use by or in connection with an instruction execution system, apparatus, or device, such as a single or multiple-core processor or processor-containing system.

The blocks or operations of a method or algorithm and functions described in connection with embodiments disclosed herein may be embodied directly in hardware, in a software module executed by a processor, or in a combination of the two. If implemented in software, the functions may be stored on or transmitted over as one or more instructions or code on a tangible, non-transitory computer-readable medium (e.g., the memory 205, the memory 1050 and/or the main memory 1090). A software module may reside in Random Access Memory (RAM), flash memory, Read Only Memory (ROM), Electrically Programmable ROM (EPROM), Electrically Erasable Programmable ROM (EEPROM), registers, hard disk, a removable disk, a CD ROM, or any other form of storage medium known in the art.

Although terms of “first” or “second” may be used to explain various components, the components are not limited to the terms. These terms should be used only to distinguish one component from another component. For example, a “first” component may be referred to as a “second” component, or similarly, and the “second” component may be referred to as the “first” component. Expressions such as “at least one of” when preceding a list of elements, modify the entire list of elements and do not modify the individual elements of the list. For example, the expression, “at least one of a, b, and c,” should be understood as including only a, only b, only c, both a and b, both a and c, both b and c, all of a, b, and c, or any variations of the aforementioned examples. As used herein the term “and/or” includes any and all combinations of one or more of the associated listed items.

Embodiments may be described with reference to acts and symbolic representations of operations (e.g., in the form of flow charts, flow diagrams, data flow diagrams, structure diagrams, block diagrams, etc.) that may be implemented in conjunction with units and/or devices discussed in more detail herein. Although discussed in a particular manner, a function or operation specified in a specific block may be performed differently from the flow specified in a flowchart, flow diagram, etc. For example, functions or operations illustrated as being performed serially in two consecutive blocks may actually be performed concurrently, simultaneously, contemporaneously, or in some cases be performed in reverse order.

While the inventive concepts have been particularly shown and described with reference to embodiments thereof, it will be understood that various changes in form and details may be made therein without departing from the spirit and scope of the following claims.

What is claimed is:

1. A log-likelihood ratio (LLR) generation method in a multiple input multiple output (MIMO) system, the LLR generation method comprising:
converting a symmetric transmission symbol into an asymmetric transmission symbol corresponding to a modulation order, the symmetric transmission symbol being included in a reception signal vector; and
generating an LLR based on the reception signal vector, a channel matrix, and the asymmetric transmission symbol by using an LLR generation algorithm.

2. The LLR generation method of claim 1, wherein the LLR generation algorithm comprises a log MAP algorithm or a max-log MAP algorithm.

3. The LLR generation method of claim 1, wherein
the LLR generation algorithm comprises a max-log MAP algorithm; and
the generating of the LLR comprises:
generating a first common variable based on the reception signal vector and the channel matrix,
calculating a Euclidean distance based on the first common variable and the asymmetric transmission symbol, and
generating the LLR based on the Euclidean distance by using the max-log MAP algorithm.

4. The LLR generation method of claim 3, wherein the calculating of the Euclidean distance is performed only on data corresponding to the asymmetric transmission symbol.

5. The LLR generation method of claim 4, wherein the Euclidean distance is a multiple of 4.

6. The LLR generation method of claim 4, further comprising:
generating a second common variable based on the first common variable,
wherein the calculating of the Euclidean distance includes calculating the Euclidean distance based on the first common variable, the second common variable, and the asymmetric transmission symbol.

7. The LLR generation method of claim 3, wherein
the asymmetric transmission symbol is included among a plurality of asymmetric transmission symbols;
the method further comprises selecting a candidate asymmetric transmission symbol from among the plurality of asymmetric transmission symbol by using a detection algorithm; and
the calculating of the Euclidean distance comprises calculating the Euclidean distance based on the candidate asymmetric transmission symbol.

8. The LLR generation method of claim 1, wherein a bit-width of the asymmetric transmission symbol is smaller than a bit-width of the symmetric transmission symbol.

9. The LLR generation method of claim 1, wherein the converting of the symmetric transmission symbol into the asymmetric transmission symbol is based on Equation 1 below
$$x = 2 \overline{x} + ( 1 + j ) , \qquad [ Equation 1 ]$$
wherein x denotes the symmetric transmission symbol and x̅ denotes the asymmetric transmission symbol.

10. A log-likelihood ratio (LLR) generation method in a multiple input multiple output (MIMO) system, the LLR generation method comprising:
generating a first common variable based on a reception signal vector and a channel matrix;
obtaining asymmetric transmission symbols based on the reception signal vector, the asymmetric transmission symbols having asymmetry corresponding to a modulation order;
selecting N transmission symbols from among the asymmetric transmission symbols, “N” being a natural number;
calculating a Euclidean distance based on the first common variable and the N transmission symbols; and
generating an LLR based on the Euclidean distance by using a max-log MAP algorithm.

11. The LLR generation method of claim 10, wherein the calculating of the Euclidean distance is performed only on data corresponding to the N transmission symbols.

12. The LLR generation method of claim 11, wherein the Euclidean distance is a multiple of 4.

13. The LLR generation method of claim 11, further comprising:
generating a second common variable based on the first common variable,
wherein the calculating of the Euclidean distance includes calculating the Euclidean distance based on the first common variable, the second common variable, and the N transmission symbols.

14. The LLR generation method of claim 10, wherein
wherein the obtaining of the asymmetric transmission symbols includes obtaining the asymmetric transmission symbols based on corresponding symmetric transmission symbols, the symmetric transmission symbols having symmetry; and
a bit-width of each of the N transmission symbols is smaller than a bit-width of a corresponding symmetric transmission symbol among the symmetric transmission symbols.

15. A multiple input multiple output (MIMO) detection circuit provided in a receiving device of a MIMO system, the MIMO detection circuit comprising:
processing circuitry configured to
generate a first common variable based on a reception signal vector and a channel matrix,
convert a symmetric transmission symbol into an asymmetric transmission symbol corresponding to a modulation order, the symmetric transmission symbol being included in the reception signal vector,
calculate a Euclidean distance based on the first common variable and the asymmetric transmission symbol, and
generate a log-likelihood ratio (LLR) based on the Euclidean distance.

16. The MIMO detection circuit of claim 15, wherein the processing circuitry is configured to:
generate a second common variable based on the first common variable, and
calculate the Euclidean distance based on the first common variable, the second common variable, and the asymmetric transmission symbol.

17. The MIMO detection circuit of claim 15, wherein the processing circuitry is configured to perform the calculation of the Euclidean distance only on data corresponding to the asymmetric transmission symbol.

18. The MIMO detection circuit of claim 16, wherein the Euclidean distance is a multiple of 4.

19. The MIMO detection circuit of claim 15, wherein a bit-width of the asymmetric transmission symbol is smaller than a bit-width of the symmetric transmission symbol.

20. The MIMO detection circuit of claim 15, wherein the processing circuitry is configured to generate the LLR by using a log MAP algorithm or a max-log MAP algorithm.
